(19) United States
(12) Patent Application Publication
(10) Pub. No.: US 2012/0145387 A1
(43) Pub. Date: Jun. 14, 2012

(54) Compositions and Methods for Servicing Subterranean Wells

(75) Inventors: Tatiana Pyatina, Bures sur Yvette (FR); Sylwia Komocki, Chatenay Malabry (FR); Michel Michaux, Verrieres-le-Buisson (FR); Simon James, Le Plessis-Robinson (FR)

(73) Assignee: Schlumberger Technology Corporation, The Hague (NL)

(21) Appl. No.: 13/383,417

(22) PCT Filed: Jul. 29, 2009
(86) PCT No.: PCT/IB2009/006890

§ 371 Date: Feb. 26, 2012

(51) Int. Cl. E21B 43/22; C09K 8/44

(52) U.S. Cl. 166/270; 523/130

(57) ABSTRACT

Disclosed are pumpable-fluid compositions and methods for establishing hydraulic isolation in cemented subterranean wells. The fluid compositions comprise solids-free solutions of water-soluble polymers. Upon entering voids and cracks in the cement sheath and contacting the set-cement surfaces, the fluid gels and forms a seal that prevents further leakage.

### BACKGROUND OF THE INVENTION

The statements in this section merely provide background information related to the present disclosure and may not constitute prior art.

This invention relates to methods for servicing subterranean wells, in particular, fluid compositions and methods for remedial operations during which the fluid compositions are pumped into a wellbore and make contact with well cements placed during primary cementing or previous remedial cementing operations.

During construction of a subterranean well, remedial operations may be required, for example, to maintain wellbore integrity during drilling, to cure drilling problems, or to repair defective primary cement jobs. Wellbore integrity may be compromised when drilling through mechanically weak formations, leading to hole enlargement. Cement slurries may be used to seal and/or consolidate the borehole walls. Remedial cementing is a common way to repair defective primary cement jobs, to either allow further drilling to proceed or to provide adequate zonal isolation for efficient well production.

After that, during well production, remedial cementing operations may be performed, for example, to restore production, change production characteristics (e.g., to alter the gas/oil ratio or control water production), or repair corroded tubulars. During a stimulation treatment, the treatment fluids typically enter the target zones but do not leak behind the casing. If poor zonal isolation behind the production casing is suspected, a remedial cementing treatment may be necessary.

Finally, well abandonment frequently involves placing cement plugs to ensure long-term zonal isolation between geological formations, replicating the previous natural barriers between zones. However, before a well can be abandoned, annular leaks are usually sealed. Squeeze cementing techniques may be applied for this purpose.

Common cementitious-fluid systems employed during squeeze-cementing operations include, but are not limited to, Portland cement slurries, calcium-aluminate cement slurries, and organic resins based on epoxies or furans.

Portland cement slurries prepared from, for example, ISO/API Class H or Class G cement, are by far the most common cementitious fluids employed in remedial cementing operations. They perform satisfactorily in many applications; however, when the size of the void from which fluid leakage occurs is very small, the cement-particle size are often too large to enter and seal the void. This problem has been mitigated to a significant extent by grinding Portland cement clinker to a finer particle-size distribution. An example of a fine-particle-size, or “microfine,” Portland cement system is SqueezeCRETE™, available from Schlumberger. Practically, SqueezeCRETE systems are capable of sealing voids or cracks as small as about 100 micrometers.

Despite the success of microfine cements, leaks may still occur when the voids or cracks in the cement sheath are smaller than 100 micrometers. As a matter of fact, there is a need to provide means to seal such small voids and cracks in or adjacent to the cement sheath and provide zonal isolation.

### SUMMARY OF THE INVENTION

The present invention fulfills this need by providing means to seal voids and cracks in or adjacent to a cement sheath in a subterranean well, and provide zonal isolation.

In a first aspect, the present invention discloses pumpable fluid compositions with the ability to enter and seal cement-sheath voids and cracks smaller than 100 micrometers. It will be appreciated that, although the primary focus is to seal voids and cracks smaller than 100 micrometers, the invention is not limited to this size criterion.

The fluid compositions comprise solutions of water-soluble polymers, including (but not limited to) polyvinylalcohol (PVA), sodium alginate, xanthan gum, guar gum, hydroxypropyl guar, carboxymethylated guar, carboxymethylhydroxyethyl cellulose, lignite polymer, graft lignin-graft sulfonate, lignin amine, graft lignin-graft carboxylate, polyaspartic acid, polyacrylic acid, or polyglutamic acid, and mixtures thereof. The solutions may be injected into voids and fractures in, or adjacent to, a cement sheath. To facilitate injection, the solution viscosity is preferably below 1000 mPa-s at 100 s⁻¹. Downhole, the solution pH increases upon contact with the cement surfaces, causing gelation. Alternatively, the presence of multivalent cations in the set cement causes a gel to form. Either way, the gel forms a hydraulic seal that provides zonal isolation.

In a preferred embodiment, the polymer used in the present invention is PVA. A preferred PVA is one with degrees of hydrolysis greater than 80 percent. Such polymer allows the obtention of a viscosity range between about 10-70 mPa-s at 4 wt % solution, at 20° C.

The solutions according to the present invention have a low solution viscosity and thus a good injectability as required in the field. After that, when the solution pH rises upon contact with the set-cement surfaces, crosslinking proceeds thereby forming a gel.

In yet a further aspect, the present invention aims at a method of servicing a subterranean well comprising preparing a pumpable water-soluble-polymer solution comprising one or more members of the list comprising polyvinylalcohol (PVA), sodium alginate, xanthan gum, guar gum, hydroxypropyl guar, carboxymethylated guar, carboxymethylhydroxyethyl cellulose, lignite polymer, lignin amine, graft lignin-graft sulfonate, graft lignin-graft carboxylate, polyaspartic acid, polyacrylic acid, or polyglutamic acid, and mixtures thereof, wherein the viscosity of the water-soluble-polymer solution is less than 1000 mPa-s at 100 s⁻¹. The solution is pumped into the well and allowed to flow into voids and cracks in, or adjacent to, the cement sheath. The solution is then allowed to react with the set-cement surfaces and form a gel, thereby forming a seal.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The inventors surprisingly found that certain water-soluble-polymer solutions form gels when they come into contact with Portland cement surfaces. Set Portland cement contains roughly 20 wt % calcium hydroxide when cured below 110° C. Without wishing to be bound by any theory, the inventors believe that the increased solution pH resulting from exposure to calcium hydroxide, as well as the presence of multivalent cations, causes the polymers to crosslink. In fact, the inventors believe that the reaction takes place with the Calcium ions present in the interstitial water that is present in the voids of the cement sheath. In other words, even if the cement is removed from water after left to equilibrate for some time, polymers according to the present invention added later on will still form a gel.

Suitable polymers include (but are not limited to) polyvinylalcohol (PVA), sodium alginate, xanthan gum, guar gum, hydroxypropyl guar, carboxymethylated guar, carboxymethylhydroxyethyl cellulose, lignite polymer, lignin amine, graft lignin-graft sulfonate, graft lignin-graft carboxylate, polyaspartic acid, polyacrylic acid, or polyglutamic acid, and mixtures thereof. To ensure injectivity, the polymer-solution viscosity should preferably be lower than 1000 mPa-s at 100 s−1. More preferably lower than 500 mPa-s at 100 s−1 when measured at 20° C.

Preferably, the fluid composition according to the present invention comprises solid-free solutions of water-soluble polymers chosen from the group consisting of polyvinylalcohol (PVA), sodium alginate, xanthan gum, guar gum, hydroxypropyl guar, carboxymethylated guar, carboxymethylhydroxyethyl cellulose, lignite polymer, lignin amine, graft lignin-graft sulfonate, graft lignin-graft carboxylate, polyaspartic acid, polyacrylic acid, or polyglutamic acid, and mixtures thereof. More preferably, the water-soluble polymers are chosen from the group consisting of polyvinylalcohol (PVA), sodium alginate, or carboxymethylated guar, and mixtures thereof.

It will also be appreciated that the disclosed solutions may respond to other cements that provide a high-pH environment or multivalent ions including, but not limited to, lime/silica blends, lime/pozzolan blends, calcium aluminate cement, magnesium oxychloride (Sorel) cement and chemically modified phosphate ceramics.

In a preferred embodiment, the water-soluble polymer is PVA. PVA may be obtained by partial or full hydrolysis of polyvinylacetate. PVA easily dissolves in water, its solubility depends, mostly, on the degree of polymerization (molecular weight) and the degree of hydrolysis, which corresponds to the amount of substituted acetyl groups. PVA and/or its co-polymers may chemically react as a linear polymer with side chains of secondary alcohol groups. In general, cross-linking of polyvinyl alcohols reduces their water sensitivity and increases their stability in solution, usually this also correspond to an increase in viscosity. The polymer may be cross-linked by any multi-functional agent that will condense with organic hydroxyl groups. Cross-linking of PVA may be used to form strong gels in the environment of set cement. In non-modified PVA, the crosslinking takes place through hydroxyl groups that form hydroxide ions at high pH. At low pH, the cross-linking does not take place; therefore, PVA solutions maintain low viscosity. It has been observed that when a PVA solution penetrates fractures, splits or fissures of cemented wells, the pH and the calcium-ion concentration increase, provoking a crosslinking reaction and thus gel formation. Said high and low pH will depend on the PVA (molecular weight and degree of polymerization). It will be within the scope of the general knowledge of the skilled person to determine said high and low pH value for each specific PVA.

In the present invention, the preferred degree of PVA hydrolysis is greater than about 80 percent. In addition the preferred PVA molecular weight is such that the viscosity of a 4 wt % solution is between about 10-70 mPa-s when measured at 20° C.

A method of applying the disclosed invention in a subterranean well comprises preparing a solution containing one or more water soluble polymers including (but not limited to) polyvinylalcohol (PVA), sodium alginate, xanthan gum, guar gum, hydroxypropyl guar, carboxymethylated guar, carboxymethylhydroxyethyl cellulose, lignite polymer, graft lignin-graft sulfonate, lignin amine, graft lignin-graft carboxylate, polyaspartic acid, polyacrylic acid, or polyglutamic acid, and mixtures thereof.

The initial viscosity of the solution is preferably less than 1000 mPa-s at 100 s−1 So that the solution can be pumped into a cemented subterranean well, whereupon the solution is able to enter voids adjacent to set cement. The solution then reacts with the set-cement surfaces to form a gel, thereby forming the required seal.

Another method of applying the disclosed invention in a subterranean well comprises focuses on the use of PVA as the water-soluble polymer. A solution is prepared containing PVA with a degree of hydrolysis greater than about 80 percent. The molecular weight of the PVA is chosen such that the viscosity of a 4 wt % solution is between about 10-70 mPa-s when measured at 20° C.

In a preferred embodiment, the initial solution pH is less than about 6.

For the methods described above, fluid placement may incorporate a variety of remedial techniques known to those skilled in the art.

### EXAMPLES

The following examples serve to further illustrate the invention.

### EXAMPLE 1

A 6 wt. % solution of super hydrolyzed PVA was prepared at 85° C. The degree of hydrolysis was greater than 93%, and the viscosity of a 4 wt % solution was between 62-67 mPa-s at 20° C. The solution was cooled down and its pH was adjusted to 4 using ascorbic acid. The solution was placed in contact a set-cement core. The pH of the solution increased to about 11 and a strong hydrogel formed.

1. A sealant composition for establishing hydraulic isolation in a cemented subterranean well, comprising a polymer solution of polyvinylalcohol (PVA), sodium alginate, xanthan gum, guar gum, hydroxypropyl guar, carboxymethylated guar, carboxymethylhydroxyethyl cellulose, lignite polymer, lignin amine, graft lignin-graft sulfonate, graft lignin-graft carboxylate, polyaspartic acid, polyacrylic acid, or polyglutamic acid, and mixtures thereof, wherein the viscosity of the polymer solution is less than 1000 mPa-s at 100 s−1.

2. A sealant composition according to claim 1 wherein the polymer is chosen from the group consisting of polyvinylalcohol (PVA), sodium alginate, xanthan gum, guar gum, hydroxypropyl guar, carboxymethylated guar, carboxymethylhydroxyethyl cellulose, lignite polymer, lignin amine, graft lignin-graft sulfonate, graft lignin-graft carboxylate, polyaspartic acid, polyacrylic acid, or polyglutamic acid and mixtures thereof wherein the viscosity of the polymer solution is less than 1000 mPa-s at 100 s−1.

3. A sealant composition according to claim 1 wherein the polymer is chosen from the group consisting of polyvinylalcohol (PVA), sodium alginate, or carboxymethylated guar, and mixtures thereof wherein the viscosity of the polymer solution is less than 1000 mPa-s at 100 s−1.

4. The composition of claim 1, wherein the pH of the solution is less than 6.

5. The composition according to claim 1 wherein the sealant composition comprises polyvinylalcohol.

6. The composition of claim 5, wherein the degree of hydrolysis of polyvinylalcohol is greater than about 80 percent.

7. The composition of claim 5, wherein the viscosity of the polyvinylalcohol solution, measured at 20° C. at a polyvinylalcohol concentration of 4 wt %, is between about 10-70 mPa-s.

8. A method of servicing a cemented wellbore in contact with a subterranean formation, comprising:
i. preparing the sealant composition comprising a polymer solution of polyvinylalcohol (PVA), sodium alginate, xanthan gum, guar gum, hydroxypropyl guar, carboxymethylated guar, carboxymethylhydroxyethyl cellulose, lignite polymer, lignin amine, graft lignin-graft sulfonate, graft lignin-graft carboxylate, polyaspartic acid, polyacrylic acid, or polyglutamic acid, and mixtures thereof, wherein the viscosity of the polymer solution is less than 1000 mPa-s at 100 s−1; ii. pumping the sealant composition into voids in the wellbore that are adjacent to set cement; and
iii. allowing the sealant composition to react with the set-cement surfaces and form a gel, thereby forming a seal.

9. The method of claim 8, wherein the wellbore has been cemented with at least one of the materials in the list comprising: Portland cement, cement kiln dust, a lime/silica blend, a lime/pozzolan blend, calcium aluminate cement, chemically bonded phosphate ceramics, and Sorel cement.

10. The method of claim 8, wherein the pH of the solution is less than 6.

11. A method of servicing a cemented wellbore in contact with a subterranean formation, comprising:
i. preparing a sealant composition comprising a polyvinylalcohol solution, wherein the viscosity of the polyvinylalcohol solution is less than 1000 mPa-s at 100 s−1;
ii. pumping the sealant composition into voids in the wellbore that are adjacent to set cement; and
iii. allowing the sealant composition to react with the set-cement surfaces and form a gel, thereby forming a seal.

12. The method of claim 11, wherein the wellbore has been cemented with at least one of the materials in the list comprising: Portland cement, cement kiln dust, a lime/silica blend, a lime/pozzolan blend, calcium aluminate cement, chemically bonded phosphate ceramics, and Sorel cement.

13. The method of claim 11, wherein the degree of hydrolysis of polyvinylalcohol is greater than about 80 percent.

14. The method of claim 11, wherein the viscosity of the polyvinylalcohol solution, measured at 20° C. at a polyvinylalcohol concentration of 4 wt %, is between about 10-70 mPa-s.

15. The method of claim 11, wherein the pH of the solution is less than 6.

16. The composition of claim 1, wherein the viscosity of the polymer solution is less than 500 mPa-s at 100 s⁻¹ when measured at 20° C.

17. The method of claim 8, wherein the viscosity of the polymer solution is less than 500 mPa-s at 100 s⁻¹ when measured at 20° C.

18. The method of claim 11, wherein the viscosity of the polymer solution is less than 500 mPa-s at 100 s⁻¹ when measured at 20° C.

19. The method of claim 8, wherein the polymer is chosen from the group consisting of polyvinylalcohol (PVA), sodium alginate, or carboxymethylated guar, and mixtures thereof wherein the viscosity of the polymer solution is less than 1000 mPa-s at 100 s−1.

20. The method of claim 19, wherein the sealant composition comprises polyvinylalcohol.
